(19) United States
(12) Patent Application Publication
(10) Pub. No.: US 2018/0367410 A1
(43) Pub. Date: Dec. 20, 2018

(54) USING NETWORK ASSISTANCE PROTOCOL FOR IMPROVING NETWORK UTILIZATION

(71) Applicant: SONY CORPORATION, Tokyo (JP)

(72) Inventors: Rickard LJUNG, Lund (SE); Martin DANIELSSON, Lund (SE)

(21) Appl. No.: 15/780,659

(22) PCT Filed: Dec. 4, 2015
(86) PCT No.: PCT/IB2015/059362

§ 371 Date: Jun. 1, 2018

(51) Int. Cl. H04L 12/24; H04L 12/927; H04L 12/801; H04L 12/911; H04L 29/08

(52) U.S. Cl. CPC H04L 41/0896; H04L 41/16; H04L 47/803; H04L 67/325; H04L 47/39; H04L 47/826; H04L 67/322; H04L 47/805

(57) ABSTRACT

An apparatus, system and method are provided for improving bandwidth utilization between an electronic device that consumes data content and a network server that provides the data content to the electronic device. Information is exchanged between the electronic device and the network server, the information indicative of at least one of activity on the electronic device or available bandwidth from the network server. The network server dynamically allocates bandwidth to the electronic device based on the exchanged information.

### TECHNICAL FIELD OF THE INVENTION

The technology of the present disclosure relates generally to delivering content to electronic devices and, more particularly, to an approach for using network assistance protocol to assist in scheduling network resources of a network for allocation to an electronic device.

### BACKGROUND

Mobile electronic devices, such as a mobile phones and tablet computers, are capable of performing a wide variety of functions. One function is the delivery of content—often over a cellular interface or a packet-switched interface—for the consumption of the content by the user of the electronic device. A typical type of content is streamed video content, web content and the like, which may be displayed on the display of the electronic device while corresponding audio is output via a speaker, earbuds, or headset.

Delivery of content to electronic devices is conventionally carried out in a relatively non-intelligent manner. For instance, in one conventional technique (e.g., adaptive bitrate streaming) the electronic device selects delivery attributes depending on historical bit rates. In this technique the device requests content at, for example, a certain bitrate and/or quality of stream. The quality of a stream is sometimes referred to by the format of the content or the corresponding codec used in the playback of the content (e.g., video formats include 1080 p, 720 p, 480 p, etc.). A mobile network cell to which the electronic device is communicatively coupled to then provides the content to the electronic device.

Mobile network cells, however, have a limited bandwidth for providing content to mobile devices within the cell. In this regard, the cell must distribute the available resources between a number of different electronic devices in a way that maximizes the experience for each user of the electronic device. Scheduling the resources between electronic devices can be difficult, as the network has limited knowledge on how the electronic devices in the cell behave. Additionally the number of electronic devices in the cell may vary, which makes it hard to plan the bandwidth requirements in the cell.

### SUMMARY

Video streaming optimizations for a network assistance interface exist. A goal of the network assistance protocol design is to improve video streaming quality to an electronic device. The method and apparatus in accordance with the present disclosure propose additions to the existing protocol that would allow the network to improve bandwidth utilization.

In accordance with the present disclosure, additions to a network assistance protocol are provided that enable a network server or the like to improve how network bandwidth is allocated to the various electronic devices on the network. The proposed additions and functions enable the electronic device and the network server to exchange information therebetween, the information enabling the network server to make intelligent choices with respect to bandwidth allocation. The additions to the protocol include, for example, the electronic device sending to the network server the time at which the electronic device will make another data request, or the network server sending a suggested time at which the electronic device should next issue a data request. Other information may include the electronic device including priority levels for each request and/or applications that are active on the electronic device. The network server can use such information in plan how network bandwidth is allocated to the various electronic devices on the network.

According to one aspect of the present disclosure, a method is provided for improving bandwidth utilization between an electronic device that consumes data content and a network server that provides the data content to the electronic device. The method includes: exchanging information between the electronic device and the network server, said information indicative of at least one of activity on the electronic device or available bandwidth from the network server; and the network server dynamically allocating bandwidth to the electronic device based on the exchanged information.

Optionally, exchanging information includes the network server providing to the electronic device suitable times at which the electronic device should request data content.

Optionally, exchanging information includes the electronic device indicating to the network server a time at which a next request for data content will be made by the electronic device.

Optionally, exchanging information includes the electronic device assigning a priority level to the next request.

Optionally, assigning a priority level includes the network server allocating credits to the electronic device when the assigned priority level is lower than a prescribed priority level.

Optionally, assigning a priority level includes the networks retrieving credits associated with the electronic device when the assigned priority level is higher than the prescribed priority level.

Optionally, the method includes preventing the electronic device from setting a priority level higher than the nominal priority level when credits associated with the electronic device are below a prescribed threshold level.

Optionally, allocating bandwidth includes reducing bandwidth to the electronic device when the associated priority level is less than the nominal priority level, and increasing bandwidth to the electronic device when the associated priority level higher to than the nominal priority level.

Optionally, exchanging information includes the electronic device providing to the network information indicating applications active on the electronic device.

Optionally, providing information indicating applications active on the electronic device includes providing information indicating a type of application that is active on the electronic device.

Optionally, the method includes the network server learning traffic patterns for different types of applications active on the electronic device.

Optionally, allocating bandwidth includes the network server mapping network utilization based on prescribed network usage of the application.

Optionally, allocating bandwidth includes the network server temporarily increasing bandwidth to the electronic device when such temporary increase will prevent an overlap between an ongoing download to the electronic device and an expected download request from another electronic device.

According to another aspect of the present disclosure, a network server is provided for improving bandwidth utilization between an electronic device that consumes data content and the network server that provides the data content to the electronic device. The network server includes: a network communications circuit over which communications with the electronic device are made via a network; and a network control circuit that, in conjunction with the network communications circuit i) exchange information with the electronic device, said information indicative of at least one of activity on the electronic device or available bandwidth from the network server, and ii) dynamically allocate bandwidth to the electronic device based on the exchanged information.

According to another aspect of the present disclosure, an electronic device is provided for improving bandwidth utilization between the electronic device and a network server that provides data content to the electronic device. The electronic device includes: an electronic device communications circuit over which communications with the network server are made via a network; and an electronic device control circuit that, in conjunction with the electronic device communications circuit exchange information with the network server, said information indicative of at least one of activity on the electronic device or available bandwidth from the network server.

Optionally, the electronic device control circuit requests data content from the network server based on available time slots provided by the network serve to the electronic device.

To the accomplishment of the foregoing and the related ends, the device and method comprises the features hereinafter fully described in the specification and particularly pointed out in the claims, the following description and the annexed drawings setting forth in detail certain illustrative embodiments, these being indicative, however, of but several of the various ways in which the principles of the invention may be suitably employed.

Although the various features are described and are illustrated in respective drawings/embodiments, it will be appreciated that features of a given drawing or embodiment may be used in one or more other drawings or embodiments of the invention.

### BRIEF DESCRIPTION OF THE DRAWINGS

FIG. 1 is a schematic view of a communication environment for an electronic device.

FIG. 2 is a timing chart illustrating the timing for data transfers to different electronic devices.

FIG. 3 is a timing chart illustrating the timing for data transfers to different electronic devices in accordance with the present disclosure, where network resources are varied to prevent overlap of data transfer between two electronic devices.

FIG. 4 illustrates a priority request that may be associated with a data transfer in accordance with the present disclosure.

FIG. 5 is a timing chart illustrating the timing for data requests made by different applications executing on an electronic device.

FIG. 6 is a flow chart illustrating exemplary steps for carrying out a method of optimizing bandwidth utilization in accordance with the present disclosure.

FIG. 7 is a schematic block diagram of an exemplary electronic device in accordance with the present disclosure.

FIG. 8 is a schematic block diagram of an exemplary network server in accordance with the present disclosure.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of delivering content to an electronic device. The electronic device is typically—but not necessarily—a mobile electronic device, and may take any form factor including, but not limited to, a mobile telephone, a tablet computing device, a laptop computer, a gaming device, a camera, or a media player. The electronic device shown in the appended figures is a mobile telephone, but applicability of aspects of the invention is not limited to mobile telephones.

With initial reference to FIG. 1, schematically illustrated is an exemplary network environment in which one or more electronic devices 10 operate. In the network environment, the electronic device 10 may carry out wireless communications. To conduct wireless communications, the electronic device 10 establishes network connectivity with one or more networks. Typically, the connection is made to a subscriber network 12 that services the physical geo-location of the electronic device 10. The subscriber network 12 also may be referred to as a radio access network. The network 12 may provide the electronic device 10 with access to the Internet 14. In most cases, the network 12 is a cellular network operated by a respective cellular service telephone company. Exemplary network access technologies for the network 12 are typically cellular circuit-switched network technologies and include, but are not limited to, global system for mobile communications (GSM), code division multiple access (CDMA), wideband CDMA (WCDMA), and advanced or alternative versions of these standards. The networks may support general packet radio service (GPRS), universal mobile telecommunications system (UMTS), 3G, 4G long-term evolution (LTE), or other standards.

The network 12 supports communications such as, but not limited to, voice communications (e.g., telephone calls), video communications (e.g., video telephony), messaging (e.g., instant messaging, text and multimedia messaging, and electronic mail messaging), data transfers, and Internet browsing. Data transfers may include, but are not limited to, the streaming of content such as video or other relatively large data files.

To support the communications activity of the electronic device 10, the network 12 may include a network server 16 (or servers). The server 16 may be configured as a typical computer system used to carry out server functions and may include a processor configured to execute software containing logical instructions that embody the functions of the server 16 and a memory to store such software and related data.

The communications between the electronic device 10 and the subscriber network 12 may be established by way of a transmission medium of the subscriber network 12. The transmission medium may be any appropriate device or assembly, but is typically an arrangement of communications base stations 18 (e.g., cellular service towers, also referred to as “cell” towers).

Accessible to the electronic device 10 via the Internet 14 may be a content server 24 that stores data that is provided to the electronic device 10. For this purpose, and to carry out other functions of the content server 24, the content server 24 may be configured as a typical computer system used to carry out server functions. Therefore, the content server 24 may include a processor configured to execute software containing logical instructions that embody the functions of the content server 24 and a memory to store such software and related data.

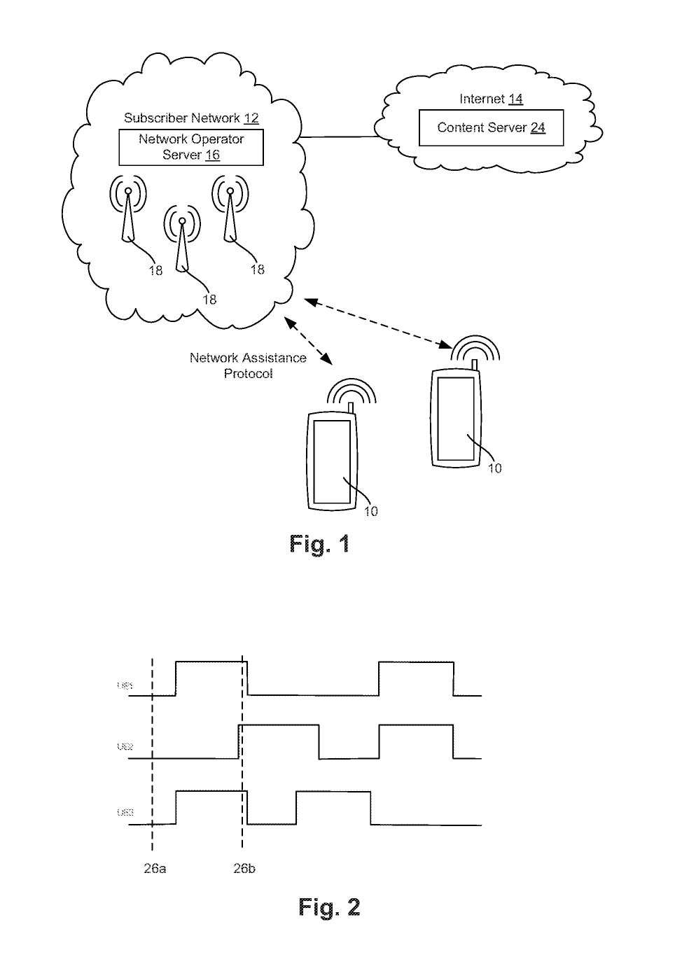

Each electronic device 10 can receive content from the content server 24 via the subscriber network 12. Typically, multiple electronic devices are simultaneously receiving content via the network server 16. However, even when multiple electronic devices 10 simultaneously receiving content in the same cell, they do not necessarily request data at the same time. Typically, data requests occur at different times, sometimes overlapping with other requests and sometimes not. FIG. 2 illustrates such timing events, where during some periods (e.g., period 26a) no electronic device 10 is requesting data and during other periods (e.g., period 26b) all electronic devices 10 are simultaneously requesting data.

In order to maximize the network utilization and provide the best possible experience for a user of each electronic device 10, it is preferable, from the network server's point of view, that the electronic devices 10 do not simultaneously request content. Conventionally, this is not possible since the network server 16 does not have any information concerning, for example, the applications executing on the electronic device 10, how the applications behave or what requirements they have.

In accordance with the present disclosure, information is exchanged between the electronic device and the network server to enable the server to better estimate when data is needed by the electronic device. Based on such knowledge, the network server can intelligently allocate bandwidth to the various electronic devices. The exchanged information for example, can be indicative of at least one of activity on the electronic device or available bandwidth from the network server. Information indicative of activity on the electronic device can include, for example, the specific applications or types of applications running on the electronic device, time periods at which data will be required by the electronic device, data consumption required by the electronic device over a time period, a priority level of the data, and so forth. Information indicative of available bandwidth on the electronic device can include time intervals in which the network expects bandwidth requirements to be below a prescribed demand level

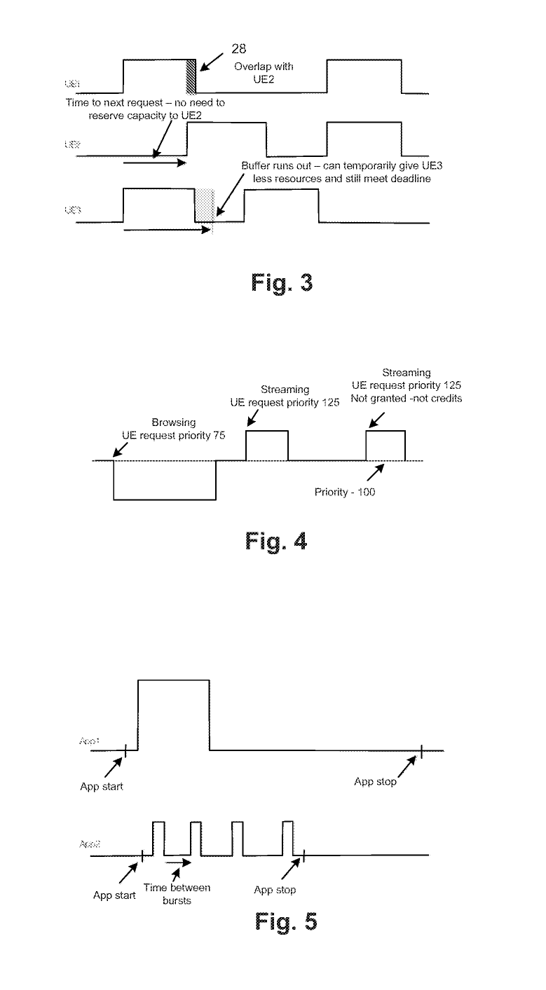

In accordance with one embodiment of the present disclosure, the electronic device 10 indicates to the network server 16 when it intends to next request data. The network server 16 then can use this information to better plan how to distribute the available resources. For instance, and with reference to FIG. 3, if a first electronic device 10 (UE1) has an ongoing download and the network server 16 knows that a final part 28 of this download will overlap with the next request from a second electronic device 10 (UE2), the network server 16 could temporarily assign more resources to the first electronic device 10 to enable the download to finish earlier, thereby avoiding the overlap.

In another embodiment, the network server 16 indicates a next suitable time for an electronic device 10 to request data. In other words, instead of the electronic device 10 indicating during a buffer refill occurrence that the next buffer refill activity is planned at a certain time, the network server 16 can indicate the next suitable time for a refill request. The electronic device 10 then can synchronize to the requested time. An advantage of this approach is network scheduling control improved.

In another embodiment, the electronic device 10 may assign a priority level to each request. More specifically, at any moment in time each electronic device 10 may request different types of data, such as video content (which has fixed update deadlines), web content (which does not have fixed update deadlines), etc. For an electronic device 10 browsing the internet 14 the download time for a web page is not as critical as the download time for video streaming, as slight delays in receiving the web page content do not significantly affect the user experience. By assigning a priority level to each request, the network server 16 can provide more resources to an electronic device 10 with high priority requests relative to an electronic device 10 with low priority requests.

For example, and with reference to FIG. 4, assume a normal priority level is 100. Using the normal priority level as a baseline, an electronic device 10 browsing the internet 14 may, for example, assign a priority level of 75 to the data request. The “lower” priority level indicates to the network server 16 that if resources are scarce, a lower bandwidth may be given to this electronic device 10. Similarly, an electronic device 10 that is streaming video content may assign a priority level of 125 to the data request. The “higher” priority level indicates to the network server 16 that extra bandwidth should be provided to this electronic device.

If there are no consequences to assigning high priority levels to data requests, then electronic devices would simply assign a high priority to all requests. To prevent this a virtual currency system may be implemented, where the network server 16 keeps track of the virtual currency for each electronic device 10. For example, when an electronic device 10 assigns a lower priority (e.g., below some prescribed level, such as 100) to the data request, the network server 16 can award virtual currency (also may be referred to as a credit or virtual credit) to the electronic device 10. If at some later time the electronic device 10 assigns a higher priority (e.g., above 100) to the data request, the network server 16 would grant the request by accepting virtual currency from the electronic device. If insufficient currency is available for the assigned priority level, then the priority level may default to 100.

Additionally, the information exchanged between the network server 16 and electronic device 10 can include information on applications that are currently active/running on the electronic device 10. Such information enables the network server 16 to map network usage to specific applications. Additionally, a network assistance function could be implemented such that the network server 16 could utilize machine learning algorithms to learn traffic patterns for different applications. Exemplary traffic patterns are illustrated in FIG. 5. The knowledge of the different traffic patterns can be used by the network server 16 to estimate deadlines for the application.

For example, and with reference to FIG. 5, the network server 16 could learn the most common time between bursts for App 2 and thereby predict when the next burst will occur. Using this knowledge, the network server 16 can allocate resources to ensure the requests made by App 2 do not time out.

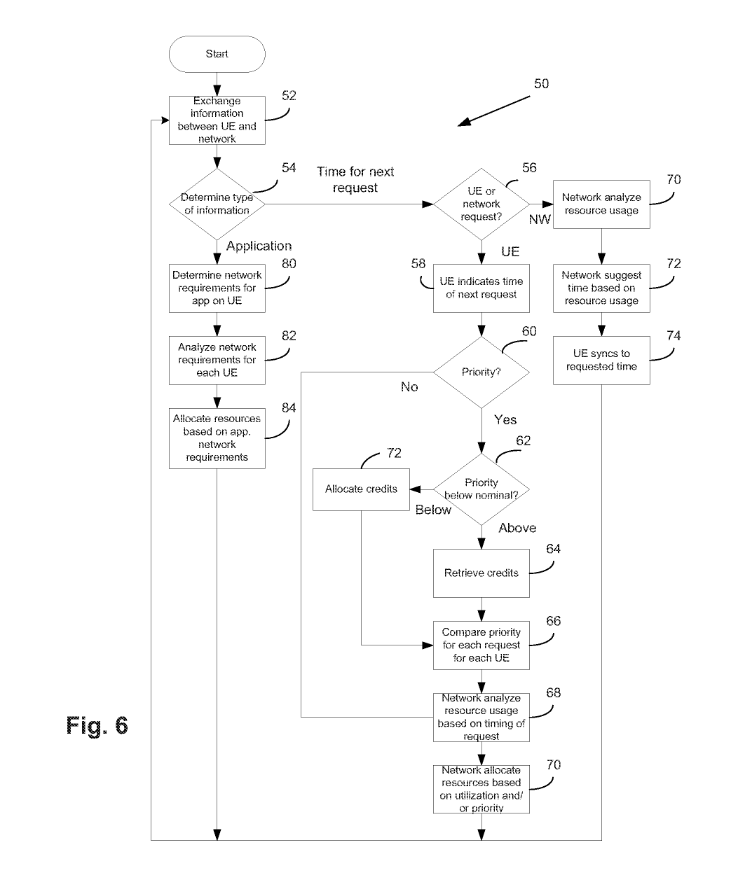

Referring now to FIG. 6, illustrated is a flow diagram that depicts an exemplary method for improving bandwidth utilization between one or more electronic devices 10 that consume data content and a network server 16 that provides the data content to the electronic device(s) 10. Although the method descriptions and flow chart may show specific orders of executing steps, the order of executing the steps may be changed relative to the order described. Also, two or more steps described in succession may be executed concurrently or with partial concurrence. One or more of the described or illustrated steps may be omitted.

The exemplary method of FIG. 6 may be implemented using coded instructions (e.g., computer readable instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. Typical non-transitory computer readable media include electronic memory devices, magnetic memory devices and optical memory devices. Portions of the method may be executed by an electronic device, such as electronic device 10 and/or network server 16. In one embodiment, to carry out the method, the logical instructions embodying the method are executed by a processor of the electronic device 10 and/or the network server 16. Alternatively, the method may be at least partially implemented in hardware of the electronic device 10 and/or network server 16 (e.g., an application-specific integrated circuit (ASIC) or the like.

Beginning at step 52, information is exchanged between the electronic device 10 and the network server 16. Based on such information, the network server 16 allocates bandwidth to electronic devices on the network. More particularly, at step 54 the type of information that was exchanged between the electronic device 10 and the network server 16 is determined. The different types of information can include, for example, information concerning applications executing on the electronic device 10, timing requests made by the electronic device 10, and/or timing requests made by the network server 16. If at step 54 it is determined the type of request is a timing request (either made by the electronic device or by the server), the method moves to step 56 where it is determined if the electronic device 10 or the network server 16 made the timing request. If the timing request is made by the electronic device 10, the method moves to step 58 where the electronic device 10 communicates to the server 16 the time at which the electronic device 10 will make the next request for data content.

The timing request made by the electronic device 10 to the network server 10 may or may not have a priority level associated with the request. At step 60, it is determined if the request has a priority level associated therewith. If a priority level is not associated with the timing request, the method moves to step 68 (discussed below). However, if a priority level is associated with the timing request, then the method moves to step 62 where it is determined if the priority level is lower than a nominal priority level (e.g., lower than 100). If the priority level is not lower than the nominal priority level, the method moves to step 64 where the network server 16 retrieves credits associated with the electronic device 10. The credits may be based on a difference between the requested priority level and the nominal priority level. For example, if the nominal priority level is 100 and the timing request is assigned a priority level of 125, then the network server 16 may retrieve 25 credits associated to the electronic device 10. If the electronic device 10 has insufficient credits for the priority level, then the priority level for the request may default to the nominal level, thus preventing the electronic device 10 from setting a priority level higher than the nominal priority. The method then moves to step 66 as discussed below.

Moving back to step 62, if the requested priority level is less than the nominal level, the method moves to step 72 where the network server 16 allocates credits to the electronic device 10. The allocated credits may be based on the difference between the nominal priority level and the requested priority level. For example, if the nominal priority level is 100 and the timing request is assigned a priority level of 75, the network server 16 allocates 25 credits to the electronic device. The method then moves to step 66.

At step 66 the network server 16 compares the priority level of each request from each of the electronic devices 10 on the network to determine which requests have the highest priority level. Next at step 68 the network server 16 analyzes the timing request for all electronic devices on the network along with the bandwidth available on the network. Based on the timing request and network load, the network server 16 allocates bandwidth to the electronic device 10 as indicated at step 70. In this regard, the network server 16 attempts to minimize overlap between data requests from the multiple electronic devices. For example, the network server 16 may allocate more bandwidth to a particular electronic device to enable a data transfer of the electronic device to complete before another electronic device makes a scheduled data request.

If at step 70 the timing requests include a priority level, the network server 16 may first allocate bandwidth to those requests having the highest priority level. Upon the requests with the highest priority level being serviced, the requests with the next highest priority level are addressed, and so on. In this manner, network bandwidth may be reduced to an electronic device when the associated priority level is less than the nominal priority level, and may be increased when the associated priority level higher than the nominal priority level.

For example, if a plurality of electronic devices have a timing request with a priority of 125, and another plurality of electronic devices have a timing request with a priority of 100 (or some other priority level lower than 125), the network server 16 will first allocate resources to the timing requests with the priority level of 125. Then, any remaining resources may be allocated to timing requests with a priority level of 100, and so on. Upon allocating bandwidth, the method moves back to step 52 and repeats.

Moving back to step 56, if the timing request is being made by the network server 16, then at step 70 the network server 16 analyzes the resource allocation on the network. For example, based on known timing of data requests from other electronic devices 10, the network server 16 may know that at a particular time period data requests will be low. Based on this knowledge, at step 72 the network server 16 can present to the electronic device 10 a suitable time at which the electronic device should request data content (e.g., during the period of low network activity), and at step 74 the electronic device synchronizes its next data request to that suggested by the network server 16. In this manner, optimal bandwidth utilization can be achieved. The method then moves back to step 52 and repeats.

Moving back to step 54, if the information exchanged between the electronic device 10 and the network server 16 includes the applications active on the electronic device, the method moves to step 80. The application information may be specific information, e.g., identify the application by name, or general information, e.g., indicate a type of application (e.g., a gaming app, a GPS app., a search engine, etc.). At step 80 the network server 16 analyzes the applications that are active on the electronic device 10 to estimate the bandwidth requirements of the electronic device. In this regard, the network server 16 may search a database that stores application-specific information. The database may include, for example, an application name entry (and/or type entry) as well as one or more resource characteristics of the application. The resource characteristics may include, for example, the average data request frequency for the application, the average resource requirement per unit of time, or other information that can be used by the network server 16 to estimate resource requirements of the application.

Alternatively, the network server 16 may execute a learning algorithm that can learn the network requirements for different types of applications. In this regard, the server 16 may learn traffic patterns for different types of applications that are active on the electronic device. The learned information can be used to dynamically update the entries in the database, or may be used as an alternative to the data obtained from the database. The server 16 then can map network utilization for each electronic device based on the estimated network usage of the applications executing on the electronic device.

More particularly, the network server 16 can estimate the total resource requirements of the electronic device 10, for example, by combining the individual resource requirements for each application executing on the electronic device 10. In this manner, the network server 16 can form an overall estimate of the network requirements for the electronic device 10 over a given period of time. This process may be repeated for each electronic device in communication with the network server 16 as indicated at step 82.

Knowing the network requirements for each electronic device 10 on the network, at step 84 the network server 16 can determine the total resource requirements for all of the electronic devices on the network. For example, the network server 16 may know that at a certain time slice it can expect a particular electronic device 10 to request a large amount of time-critical data, while at another time slice the network server can expect another electronic device to request a large amount of non-time critical data. Based on this knowledge, the network server 16 can allocate additional resources to the electronic device 10 that requests the time critical data and less resources to the electronic device 10 that requests the non-time critical data. Upon allocating the resources, the method moves back to step 52 and repeats.

Accordingly, by exchanging information between the electronic device 10 and the network server 16, intelligent choices can be made with respect to the allocation of bandwidth to the various electronic device on the network. In this manner, bandwidth utilization on the network can be optimized, thereby providing a better experience for the user.

Referring now to FIG. 7, a schematic block diagram of the electronic device 10 in its exemplary form as a mobile telephone is illustrated. The electronic device 10 includes a control circuit 92 that is responsible for overall operation of the electronic device 10, including controlling content streaming. The control circuit 92 includes a processor 94 that executes an operating system 96 and various applications 98. Typically, control over the content streaming protocol of the electronic device 10 is embodied as part of the operating system 96. In other embodiments, this functionality may be embodied as a dedicated application.

The operating system 96, the applications 98, and stored data 100 (e.g., data associated with the operating system 96, the applications 98, and user files), are stored on a memory 102. The operating system 96 and applications 98 are embodied in the form of executable logic routines (e.g., lines of code, software programs, etc.) that are stored on a non-transitory computer readable medium (e.g., the memory 102) of the electronic device 10 and are executed by the control circuit 92. The described operations may be thought of as a method that is carried out by the electronic device 10.

The processor 94 of the control circuit 92 may be a central processing unit (CPU), microcontroller, or microprocessor. The processor 94 executes code stored in a memory (not shown) within the control circuit 92 and/or in a separate memory, such as the memory 102, in order to carry out operation of the electronic device 10. The memory 102 may be, for example, one or more of a buffer, a flash memory, a hard drive, a removable media, a volatile memory, a non-volatile memory, a random access memory (RAM), or other suitable device. In a typical arrangement, the memory 102 includes a non-volatile memory for long term data storage and a volatile memory that functions as system memory for the control circuit 92. In addition, the memory 102 may include a media buffer 103 in which streamed content is temporarily stored before consumption. The memory 102 may exchange data with the control circuit 92 over a data bus. Accompanying control lines and an address bus between the memory 102 and the control circuit 92 also may be present. The memory 102 is considered a non-transitory computer readable medium.

The electronic device 10 includes communications circuitry that enables the electronic device 10 to establish various wireless communication connections. In the exemplary embodiment, the communications circuitry includes a radio circuit 104 (sometimes referred to as a modem). The radio circuit 104 includes one or more radio frequency transceivers and an antenna assembly (or assemblies). In the case that the electronic device 10 is a multi-mode device capable of communicating using more than one standard and/or over more than one radio frequency band, the radio circuit 104 represents one or more than one radio transceiver, one or more than one antenna, tuners, impedance matching circuits, and any other components needed for the various supported frequency bands and radio access technologies. The radio circuit 104 further represents any radio transceivers and antennas used for local wireless communications directly with another electronic device, such as over a Bluetooth interface.

The electronic device 10 further includes the display 109 for displaying information to a user. The display 109 may be coupled to the control circuit 92 by a video circuit 106 that converts video data to a video signal used to drive the display 109. The video circuit 106 may include any appropriate buffers, decoders, video data processors and so forth.

The electronic device 10 may include one or more user inputs 108 for receiving user input for controlling operation of the electronic device 10. Exemplary user inputs include, but are not limited to, a touch input 110 that overlays or is part of the display 109 for touch screen functionality, one or more buttons 112, motion sensors 114 (e.g., gyro sensors, accelerometers), and so forth.

The electronic device 10 may further include a sound circuit 116 for processing audio signals. Coupled to the sound circuit 116 are a speaker 118 and a microphone 120 that enable audio operations that are carried out with the electronic device 10 (e.g., conduct telephone calls, output sound, capture audio for videos, etc.). The sound circuit 116 may include any appropriate buffers, encoders, decoders, amplifiers and so forth.

The electronic device 10 may further include one or more input/output (I/O) interface(s) 122. The I/O interface(s) 122 may be in the form of typical electronic device I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 122 and power to charge a battery of a power supply unit (PSU) 124 within the electronic device 10 may be received over the I/O interface(s) 122. The PSU 124 may supply power to operate the electronic device 10 in the absence of an external power source.

The electronic device 10 also may include various other components. As an example, one or more cameras 126 may be present for taking photographs or video, or for use in video telephony. As another example, a position data receiver 128, such as a global positioning system (GPS) receiver, may be present to assist in determining the location of the electronic device 10. The electronic device 10 also may include a subscriber identity module (SIM) card slot 130 in which a SIM card 132 is received. The slot 130 includes any appropriate connectors and interface hardware to establish an operative connection between the electronic device 10 and the SIM card 132.

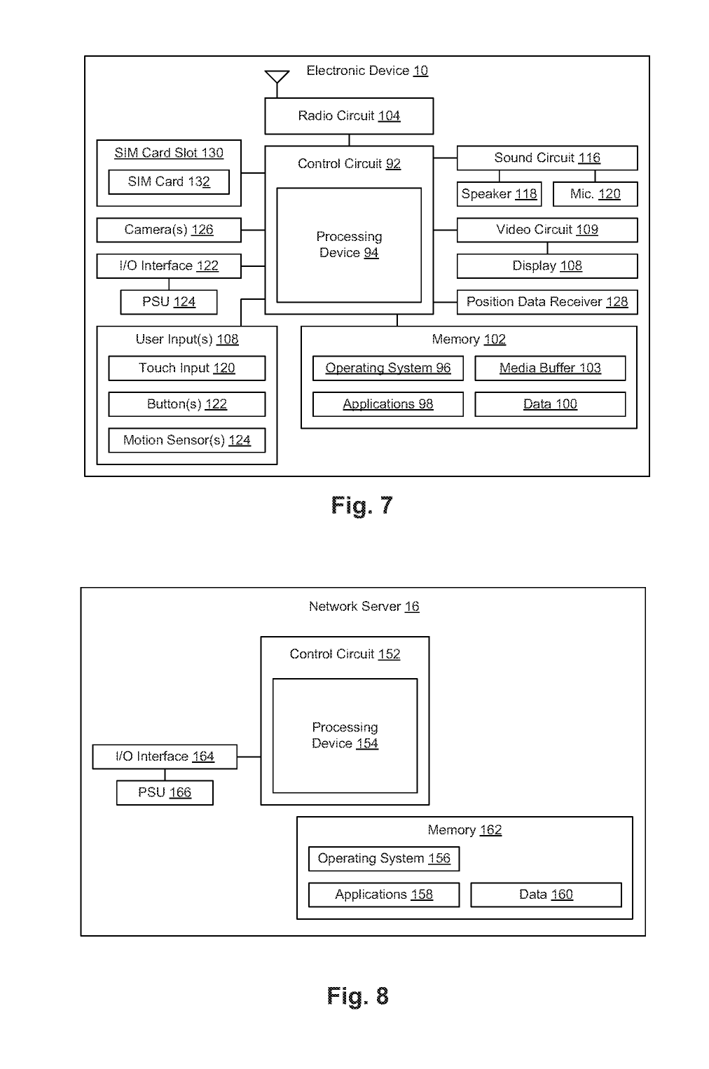

With additional reference to FIG. 8, a schematic block diagram of the network in its exemplary form as a network server 16 is illustrated. The network server 16 includes a control circuit 152 that is responsible for overall operation of the network server 16, including controlling the allocation of resources to electronic devices 10. The control circuit 152 includes a processor 154 that executes an operating system 156 and various applications 158. Control over the allocation of resources is embodied as part of the operating system 156. In other embodiments, this functionality may be embodied as a dedicated application.

The operating system 156, the applications 158, and stored data 160 (e.g., data associated with the operating system 156, the applications 158, and user files), are stored on a memory 162. The operating system 156 and applications 158 are embodied in the form of executable logic routines (e.g., lines of code, software programs, etc.) that are stored on a non-transitory computer readable medium (e.g., the memory 162) of the network server 16 and are executed by the control circuit 152. The described operations may be thought of as a method where at least portions of which are carried out by the network server 16.

The processor 154 of the control circuit 152 may be a central processing unit (CPU), microcontroller, or microprocessor. The processor 154 executes code stored in a memory (not shown) within the control circuit 152 and/or in a separate memory, such as the memory 162, in order to carry out operation of the network server 16. The memory 162 may be, for example, one or more of a buffer, a flash memory, a hard drive, a removable media, a volatile memory, a non-volatile memory, a random access memory (RAM), or other suitable device. In a typical arrangement, the memory 162 includes a non-volatile memory for long term data storage and a volatile memory that functions as system memory for the control circuit 152. The memory 162 may exchange data with the to control circuit 152 over a data bus. Accompanying control lines and an address bus between the memory 162 and the control circuit 152 also may be present. The memory 162 is considered a non-transitory computer readable medium.

The network server 16 may further include one or more input/output (I/O) interface(s) 164. The I/O interface(s) 164 may be in the form of typical I/O interfaces and may include one or more electrical connectors for operatively connecting the electronic device 10 to another device (e.g., a computer) or an accessory (e.g., a keyboard device) via a cable. Further, operating power may be provided via a power supply unit (PSU) 166 within the network server 16.

Although certain embodiments have been shown and described, it is understood that equivalents and modifications falling within the scope of the appended claims will occur to others who are skilled in the art upon the reading and understanding of this specification.

1. A method of improving bandwidth utilization between an electronic device that consumes data content and a network server that provides the data content to the electronic device, the method comprising:
exchanging information between the electronic device and the network server, said information indicative of at least one of activity on the electronic device or available bandwidth from the network server; and
the network server dynamically allocating bandwidth to the electronic device based on the exchanged information.

2. The method according to claim 1, wherein exchanging information includes the network server providing to the electronic device suitable times at which the electronic device should request data content.

3. The method according to any one of claim 1, wherein exchanging information includes the electronic device indicating to the network server a time at which a next request for data content will be made by the electronic device.

4. The method according to claim 3, wherein exchanging information includes the electronic device assigning a priority level to the next request.

5. The method according to claim 4, wherein assigning a priority level includes the network server allocating credits to the electronic device when the assigned priority level is lower than a prescribed priority level.

6. The method according to any one of claim 4, wherein assigning a priority level includes the networks retrieving credits associated with the electronic device when the assigned priority level is higher than the prescribed priority level.

7. The method according to any one of claim 4, further comprising preventing the electronic device from setting a priority level higher than the nominal priority level when credits associated with the electronic device are below a prescribed threshold level.

8. The method according to any one of claim 4, wherein allocating bandwidth includes reducing bandwidth to the electronic device when the associated priority level is less than the nominal priority level, and increasing bandwidth to the electronic device when the associated priority level higher than the nominal priority level.

9. The method according to any one of claim 1, wherein exchanging information includes the electronic device providing to the network information indicating applications active on the electronic device.

10. The method according to claim 9, wherein providing information indicating applications active on the electronic device includes providing information indicating a type of application that is active on the electronic device.

11. The method according to any one of claims 9, further comprising the network server learning traffic patterns for different types of applications active on the electronic device.

12. The method according to any one of claim 9, wherein allocating bandwidth includes the network server mapping network utilization based on prescribed network usage of the application.

13. The method according to any one of claim 1, wherein allocating bandwidth includes the network server temporarily increasing bandwidth to the electronic device when such temporary increase will prevent an overlap between an ongoing download to the electronic device and an expected download request from another electronic device.

14. A network server for improving bandwidth utilization between an electronic device that consumes data content and the network server that provides the data content to the electronic device, the network server comprising:
a network communications circuit over which communications with the electronic device are made via a network; and
a network control circuit that, in conjunction with the network communications circuit
exchange information with the electronic device, said information indicative of at least one of activity on the electronic device or available bandwidth from the network server; and
dynamically allocate bandwidth to the electronic device based on the exchanged information.

15. An electronic device for improving bandwidth utilization between the electronic device and a network server that provides data content to the electronic device, the electronic device comprising:
an electronic device communications circuit over which communications with the network server are made via a network; and
an electronic device control circuit that, in conjunction with the electronic device communications circuit
exchange information with the network server, said information indicative of at least one of activity on the electronic device or available bandwidth from the network server.

16. The electronic device according to claim 15, wherein the electronic device control circuit requests data content from the network server based on available time slots provided by the network serve to the electronic device.

17. A system, comprising the network server according to claim 15.
